(19) United States
(12) Patent Application Publication
(10) Pub. No.: US 2019/0055129 A1
(43) Pub. Date: Feb. 21, 2019

(54) Formation of Interlayer Covalent Bonds in Bilayer, Trilayer and Multilayer Graphene

(71) Applicant: University of Massachusetts, Boston, MA (US)

(72) Inventors: Christos Dimitrakopoulos, Suffield, CT (US); Dimitrios Maroudas, Amherst, MA (US); Yuxi Wang, Amherst, MA (US)

(21) Appl. No.: 16/041,404

(22) Filed: Jul. 20, 2018

Related U.S. Application Data
(60) Provisional application No. 62/535,569, filed on Jul. 21, 2017.

(51) Int. Cl. C01B 32/194; C01B 32/188; C01B 32/186; B01J 19/08

(52) U.S. Cl. CPC C01B 32/194; C01B 32/188; C01B 32/186; B01J 2219/0879; C01B 2204/04; C01P 2002/82; B01J 2219/0896; B01J 19/08

(57) ABSTRACT

An embodiment according to the invention provides methods for making interlayer covalent bonds in bilayer, trilayer, and multilayer graphene. Raman spectroscopy is used to characterize the resulting material, and the Raman peak at approximately 1330 cm⁻¹ coincides with the characteristic peak of diamond and polycrystalline nanodiamond peaks published in the art. This indicates that the process induces the formation of sp³ carbon-carbon (C—C) bonds (similar to the ones in diamond) between the graphene layers. The graphene bilayer or multilayer converts to sp³ bonded carbon only partially, as the Raman spectrum also indicates a strong component of graphene still remaining in the bilayer or multilayer.

### RELATED APPLICATION

This application claims the benefit of U.S. Provisional Application No. 62/535,569, filed on Jul. 21, 2017. The entire teachings of the above application are incorporated herein by reference.

### GOVERNMENT SUPPORT

This invention was made with government support under Grant No. AR0000000009604 NU 504081-78050B PRIME ARMY from the U.S. Army Research Laboratory, and under Grant No. AR0000000009670 WPI 215464 PRIME ARMY from the U.S. Army Research Laboratory. The government has certain rights in the invention.

### BACKGROUND

Graphene is an atomically thin two-dimensional (2D) sheet of covalently bonded carbon atoms arranged in a hexagonal, honeycomb-like pattern. Graphene exhibits spectacular mechanical properties, as, for example, a Young modulus that approaches 1 TPa and tensile strength that is an order of magnitude higher than that of the best steel, for the same sample thickness. The thickness of a graphene monolayer is 0.34 nm, thus for macroscopic application thousands of graphene layers would have to be stacked together, because, while the strength of single-layer graphene is outstanding, single-layer graphene is too thin for practical applications. Unfortunately, the weak van der Waals interlayer forces acting between consecutive graphene layers within the stack are responsible for the low shear strength of the stack.

Therefore, there is an ongoing need to develop techniques for interlayer bonding in bilayer, trilayer and multilayer stacks of graphene layers by incorporating covalent bonds between adjacent graphene layers.

### SUMMARY

An embodiment according to the invention provides methods for making interlayer covalent bonds in bilayer, trilayer, and multilayer graphene. Raman spectroscopy is used to characterize the resulting material, and the Raman peak at approximately 1330 cm⁻¹ coincides with the characteristic peak of diamond and polycrystalline nanodiamond peaks published in the art. This indicates that the process induces the formation of sp³ carbon-carbon (C—C) bonds (similar to the ones in diamond) between the graphene layers. The graphene bilayer or multilayer converts to sp³ bonded carbon only partially, as the Raman spectrum also indicates a strong component of graphene still remaining in the bilayer or multilayer.

Methods in accordance with an embodiment of the invention for making interlayer covalent bonds in bilayer, trilayer, and multilayer graphene include hydrogenation by annealing in H₂ forming gas (such as by annealing in an Ar/H₂ gas) and hydrogenation by the use of a hydrogen plasma, as described further below. Further methods are taught herein.

In accordance with an embodiment of the invention, there is provided a method of forming an interlayer bond between two or more layers of graphene. The method comprises positioning at least two layers of graphene in a stacked arrangement; and performing a hydrogenation treatment on the at least two layers of graphene to induce formation of carbon-carbon covalent bonds between carbon atoms on different neighboring layers of the at least two layers of graphene for at least a portion of the carbon atoms on at least a portion of the area of the at least two layers of graphene.

In further, related embodiments, performing the hydrogenation treatment may comprise performing an annealing process on the at least two layers of graphene in the stacked arrangement. Performing the annealing process may comprise performing an annealing process in the presence of at least hydrogen gas at a temperature between about 400° C. and about 1000° C. The annealing process may be performed in the presence of hydrogen gas and a carrier gas, for example argon. Performing the hydrogenation treatment may comprise performing a plasma process on the at least two layers of graphene in the stacked arrangement. The plasma process may comprise a hydrogen plasma process. The plasma process may be performed at a temperature between about 25° C. and 600° C.

In further related embodiments, the method may comprise performing a subsequent hydrogen removal treatment on the at least two layers of graphene. The subsequent hydrogen removal treatment may comprise annealing under Ultra-High Vacuum (UHV) conditions, such as a pressure of less than about 10⁻⁸ Torr. The subsequent hydrogen removal treatment may be performed during production of more than three layers of graphene and after more than two layers of graphene have been treated according to any of the foregoing methods. The subsequent hydrogen removal treatment may be performed at a temperature between about 400° C. and about 600° C. The at least two layers of graphene may comprise epitaxial graphene or polycrystalline graphene.

In another embodiment according to the invention, there is provided a method of breaking the planar configuration of graphene in at least a portion of the area of at least two different neighboring layers of graphene to create sp³ configuration bonds and thereby to create a tetrahedral geometry in at least portion of the carbon atoms of each of the neighboring layers of graphene. The method comprises positioning at least two layers of graphene in a stacked arrangement; and performing a hydrogenation treatment on the at least two layers of graphene to induce formation of carbon-carbon covalent bonds between carbon atoms on different neighboring layers of the at least two layers of graphene for at least a portion of the carbon atoms on at least a portion of the area of the at least two layers of graphene. Any of the methods taught herein may be used in combination with such a method.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIGS. 1A and 1B are diagrams showing characteristic features found in Raman spectra in accordance with the prior art.

FIG. 2 is a diagram showing the results of performing Raman spectroscopy on two-layer Chemical Vapor Deposition (CVD) graphene, which was bonded using a method in accordance with an embodiment of the invention.

FIG. 3 is a diagram showing results of performing Raman spectroscopy on three-layer CVD graphene, which was treated with techniques in accordance with an embodiment of the invention.

FIG. 4 is a diagram of the results of Raman spectroscopy performed on a single layer of CVD graphene, which was performed as a control in an experiment in accordance with an embodiment of the invention.

FIG. 5 is a diagram of the results of Raman spectroscopy performed on two layers of CVD graphene, without a hydrogenation step having been performed first, which was performed as a control experiment in accordance with an embodiment of the invention.

FIG. 6 is a diagram of the results of Raman spectroscopy before and after each of an annealing process and a plasma treatment for hydrogenation of graphene layers, in accordance with an embodiment of the invention.

FIG. 7 is a diagram of the results of Raman spectroscopy before and after an annealing process at 400° C. and 1000° C. for both two-layer and three-layer graphene, in accordance with an embodiment of the invention.

FIG. 8 is a schematic block diagram of a method in accordance with an embodiment of the invention.

FIGS. 9A and 9B are diagrams illustrating the results of Raman spectroscopy after the process of the embodiment of FIG. 8, by comparison with another technique.

FIG. 10 is a schematic block diagram of another method in accordance with an embodiment of the invention.

FIG. 11 is a diagram illustrating a graphane band structure, in accordance with the prior art.

FIG. 12 is a diagram illustrating the optical bandgap of a hydrogenated sample in an experiment in accordance with an embodiment of the invention.

### DETAILED DESCRIPTION

A description of example embodiments follows.

An embodiment according to the invention provides methods for making interlayer covalent bonds in bilayer, trilayer, and multilayer graphene. Raman spectroscopy is used to characterize the resulting material, and the Raman peak at approximately 1330 cm⁻¹ coincides with the characteristic peak of diamond and polycrystalline nanodiamond peaks published in the art. This indicates that the process induces the formation of sp³ carbon-carbon (C—C) bonds (similar to the ones in diamond) between the graphene layers. The graphene bilayer or multilayer converts to sp³ bonded carbon only partially, as the Raman spectrum also indicates a strong component of graphene still remaining in the bilayer or multilayer. This is in agreement with theoretical predictions, and with the embodiments of a prior patent application on the formation of such structures, that is, U.S. Patent App. Pub. No. 2016/0207291, the entire teachings of which are hereby incorporated herein by reference.

Methods in accordance with an embodiment of the invention for making interlayer covalent bonds in bilayer, trilayer, and multilayer graphene include hydrogenation by annealing in H₂ forming gas (such as by annealing in an Ar/H₂ gas) and hydrogenation by the use of a hydrogen plasma, as described further below. Further methods are taught herein.

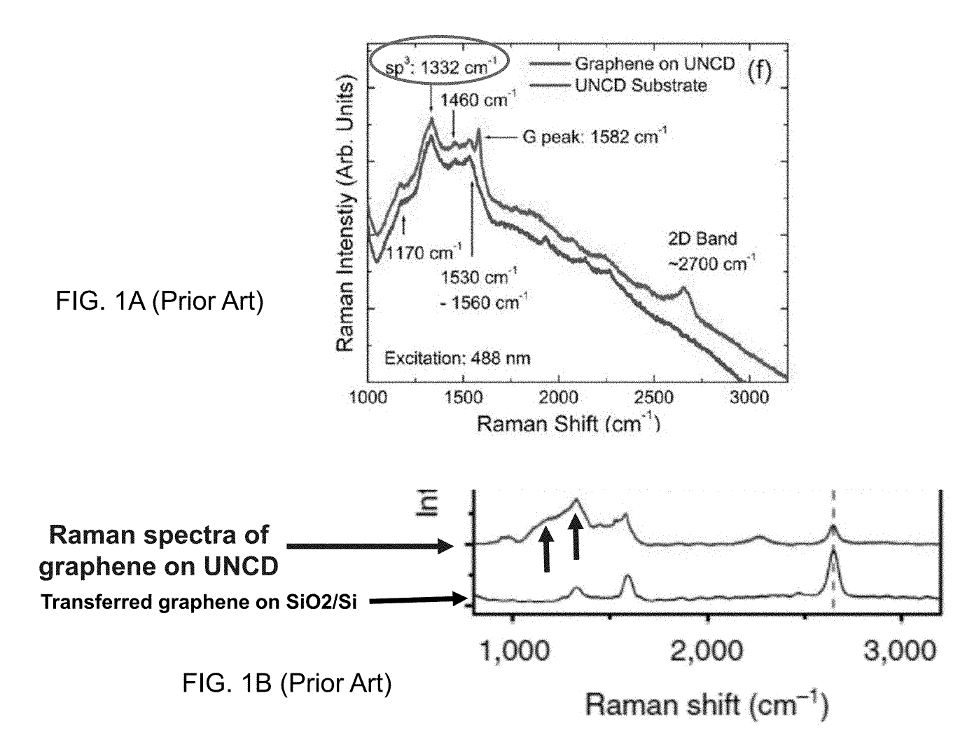

Methods in accordance with an embodiment of the invention have been used on more than one layer of graphene, and the resulting layered films have been characterized in order to identify carbon-carbon (C—C) sp³ interlayer bonding in the layered films. In order to do this, two characteristic features are used in Raman spectra in order to identify the sp³ interlayer bonding: 1) a C—C sp³ peak in the Raman spectra at about 1326 to 1332 cm⁻¹; and 2) a broad shoulder in the Raman spectra beginning at about 1250 cm⁻¹. These features have been recognized as being characteristic of C—C sp³ bonding, for example in the work shown in FIGS. 1A and 1B. FIG. 1A shows graphene on ultrananocrystalline diamond (UNCD) film (see Yu et al. Nano Lett. 2012, 12, 1603-1608). FIG. 1B shows Raman spectra of graphene on UNCD, and transferred graphene on SiO₂/Si (see Berman et al., Nature Communications 7:12099 (2016).

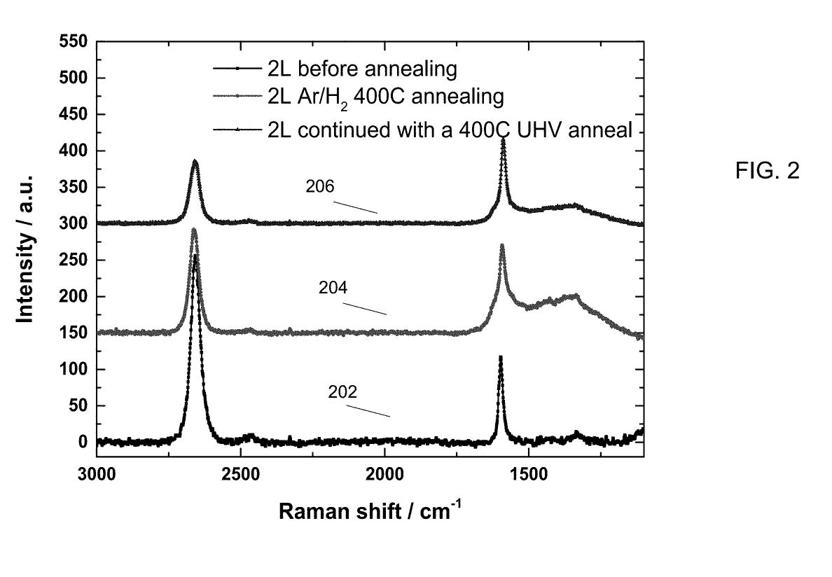

In FIG. 2, there are shown the results of performing Raman spectroscopy on two-layer Chemical Vapor Deposition (CVD) graphene, which was transferred with a standard PMMA process, and which was bonded using a method in accordance with an embodiment of the invention. It can be seen that in trace 202, which is the two-layer structure before annealing in accordance with an embodiment of the invention, there is no shoulder band between 1250 cm⁻¹ and 1590 cm⁻¹, and no peak at 1330 cm⁻¹. After Ar/H₂ annealing, the 2D/G ratio decreases and a tall, broad D-G band shoulder emerges between 1250 cm⁻¹ and 1590 cm⁻¹. 2D/G ratio decrease continues with UHV anneal. This shoulder region remains present after subsequent HV annealing, though it is slightly reduced in size.

In trace 204 of the embodiment of FIG. 2, the bilayer graphene was annealed at 400° C. in accordance with an embodiment of the invention, and it can be seen that the whole region between 1250 cm⁻¹ and 1590 cm⁻¹ is elevated, and that there is a peak at 1330 cm⁻¹. These features suggest the presence of a carbon-carbon sp³ bond between the layers. It also appears to be the case in trace 204 that there is some carbon-hydrogen bonding in an sp³ configuration, since there is a feature between about 1340 cm⁻¹ and 1400 cm⁻¹ present. It is, therefore, suggested that some sp³ configuration bonds are formed between carbon and hydrogen, and some between carbon and carbon between layers, in trace 204. In addition, it can be seen in FIG. 2 that trace 202 has a higher ratio of the peak at about 2700 cm⁻¹, which signifies sp² carbon in graphene and graphite, to the height of the peak at 1590 cm⁻¹, which is the peak for sp³ carbon, than the same ratio in trace 204. The reduction in this ratio of the two peaks also appears to show the formation of sp³ configuration bonds in trace 204, resulting from an embodiment in accordance with the invention, as the results of formation of both interlayer carbon-carbon bonds and non-interlayer carbon-hydrogen bonds.

In addition, in trace 206 of the embodiment of FIG. 2, there are shown the results of Raman spectroscopy performed after having continued the treatment of the two-layer graphene structure, after the annealing used for trace 204, by using a 400° C. Ultra-High Vacuum (UHV) anneal, in accordance with an embodiment of the invention. Here, it can be seen in trace 206 that there appears to be some reduction in the peak for the carbon-hydrogen bonds between about 1340 cm⁻¹ and 1400 cm⁻¹ as compared with trace 204. Therefore, it is believed that the UHV process used for trace 206 removes at least a portion of the carbon-hydrogen bonds that are present after the technique used for trace 204.

In an embodiment according to the invention, a technique of hydrogenation can be used, as with the Ar/H₂ annealing at 400° C. used for trace 204 in FIG. 2, to produce interlayer C—C bonding between graphene. This process can be repeated in order to build up more than two layers of graphene, including large stacks of the order of ten thousand or twenty thousand or more layers of graphene. After a desired number of layers are formed, the UHV annealing process used for trace 206 in FIG. 2, can be performed in order to remove the carbon-hydrogen bonds. This second step can be performed after every two layers, or after a number of layers that is greater than two, including even at only the final step of many layers of graphene.

In accordance with an embodiment of the invention, a process of high temperature annealing is used to hydrogenate at least two layers of graphene. This hydrogenating process is believed to push the carbon in the graphene towards forming an sp³ formation, which results, in some cases, in an interlayer carbon-carbon bond, and in other cases, in a carbon-hydrogen bond. Subsequently, an embodiment can include using a UHV or other process that promotes the removal of hydrogen and destruction of the carbon-hydrogen bonds. For example, when a UHV anneal process is used at a temperature of 400° C., as for trace 206 of FIG. 2, it is believed that hydrogen gas is removed by the high vacuum as carbon-hydrogen bonds are broken.

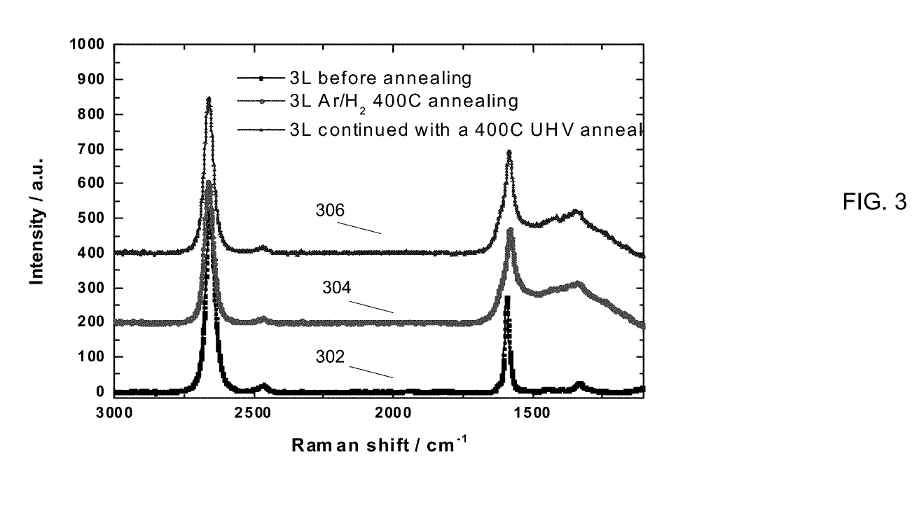

FIG. 3 is a diagram showing results similar to those of FIG. 2, with three-layer CVD graphene, which was transferred with a standard PMMA process and then treated with techniques in accordance with an embodiment of the invention. Traces 302, 304 and 306 are analogous to traces 202, 204 and 206 of FIG. 2, except with three layers rather than two. After Ar/H₂ annealing, the 2D/G ratio decreases and a tall, broad D-G band shoulder emerges between 1250 cm⁻¹ and 1590 cm⁻¹. There are no noticeable changes in this ratio after HV annealing. The shoulder region remains intact after subsequent HV annealing. It is believed that, if the shoulder region were due to attached H on sp³ C, it would have been annealed out, based on literature. The Ar/H₂ anneal does not affect the 2D/G peak ratio of three-layer graphene as much as in the two-layer sample. It is possible that the bottom layer (the third from the surface) remains unaffected due to shielding by the bilayer on top of it.

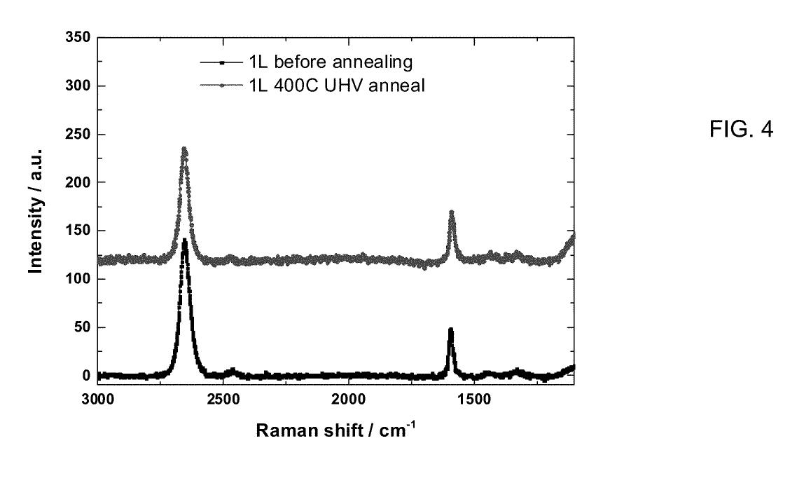

FIG. 4 is a diagram of the results of Raman spectroscopy performed on a single layer of CVD graphene, transferred with a standard PMMA process, which was performed as a control. The top trace is for one layer 400° C. with UHV anneal, and bottom trace is one layer before annealing. The control contains some two-layer regions. It can be seen that the Raman spectrum of the single layer is unaffected by UHV annealing.

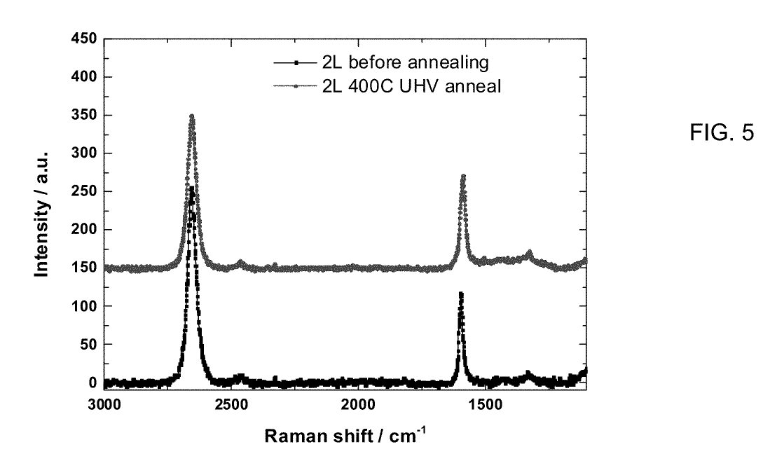

FIG. 5 is a diagram of the results of Raman spectroscopy performed on two layers of CVD graphene, without a hydrogenation step having been performed first, which was performed as a control experiment. Two-layer CVD graphene was transferred with a standard PMMA process. The bottom trace is for two layers before annealing, and the top trace is for two layers 400° C. UHV anneal. The Raman spectrum is unaffected by the HV annealing. The plain anneal in UHV does not affect the sp² structure of two-layer graphene. It is believed that FIG. 5 is consistent with belief that hydrogenation, in accordance with an embodiment of the invention, has a role in inducing an sp³ formation in the graphene.

Without wishing to be bound by theory, it is believed that the sp³ formation in accordance with an embodiment of the invention assists with breaking the planarity of the graphene and thereby inducing the graphene layers to be in sufficient proximity to form interlayer carbon-carbon bonds. The graphene layers have a wide, 0.34 nm van der Waals distance between layers, whereas the length of an sp³ bond is about 0.14 nm, less than half the distance between layers, so that without hydrogenation the carbons on neighboring layers of the graphene are too far apart. However, with hydrogenation in accordance with an embodiment of the invention, the hydrogen reacts with one carbon to form a tetrahedral configuration of carbon in one of the graphene layers, resulting in a 109-degree tetrahedral bond angle. Thus, three neighboring carbons are then below the plane of the graphene, in order to keep the 109-degree tetrahedral configuration. This encourages proximity of carbons in neighboring layers of the graphene layer, thereby encouraging carbon-carbon interlayer bonding. When a carbon on the neighboring layer has the same tetrahedral formation created, by virtue of the hydrogenation, the result is that two carbons on different layers of graphene are now close enough to form an sp³ carbon-carbon bond between layers. It is believed that hydrogen, used in the hydrogenation, is small enough to go through the graphene layers, thereby assisting in creating the sp³ formation. It is also believed that subsequent use of a UHV annealing or other process assists in breaking the carbon-hydrogen bonds and promoting the formation of carbon-carbon bonds between layers, if they have not already formed in the sp³ formation after the first step of hydrogenation. Earlier work by Maroudas et al. shows that the carbon-carbon bond can be stable between layers of graphene. See U.S. Patent App. Pub. No. 2016/0207291, the entire teachings of which are hereby incorporated herein by reference.

Below is an outline of an annealing process to promote hydrogenation of graphene and thereby form carbon-carbon interlayer bonds, in accordance with an embodiment of the invention. In this technique, argon is used as a carrier gas, but it will be appreciated that other carrier gases may be used. This process of Ar/H₂ annealing is outlined as follows:

1. Put the transferred graphene on SiO₂/Si sample in the CVD chamber and pump down the system to low pressure (<10⁻⁴ Torr).

2. Open the Ar (30 sccm) and the H₂ (30 sccm) gas valves to begin gas flow so that the pressure in the chamber is 0.3 Torr.

3. Heat the furnace up to 400° C. or 1000° C., and stabilize the temperature for 20 minutes.

4. Anneal the graphene sample for 1 hour.

5. Move the furnace to allow for fast cooling down to room temperature, then stop the gas flow and remove the graphene sample from the chamber.

Below is an outline of a high temperature hydrogen plasma process that can be used to promote hydrogenation of graphene and thereby form carbon-carbon interlayer bonds, in accordance with another embodiment of the invention. In some cases, this process may produce a higher yield than the annealing process outlined above. As used herein, a “hydrogen plasma process” may include a process such as, for example, the process outlined below, or another process involving the formation of hydrogen into the plasma state, which is a gaseous mixture of negatively charged electrons and highly charged positive ions, being created for example by sufficient heating of hydrogen gas. The high temperature hydrogen plasma process is outlined as follows:

1. Put the transferred graphene on SiO₂/Si sample in the CVD chamber and pump down the system to low pressure (<10⁻⁴ Torr).

2. Open the H₂ (20 sccm) gas valves to begin gas flow so that the pressure in the chamber is 0.1 Torr.

3. Heat the furnace up to 400° C. or 1000° C., and stabilize the temperature for 20 minutes.

4. Open the plasma to 20 W and react for 5 min.

5. Move the furnace to allow for fast cooling down to room temperature, shut down the H₂ flow and open the Ar (50 sccm), then stop the Ar flow and remove the graphene sample from the chamber after cooling.

In accordance with an embodiment of the invention, after using a hydrogenation technique such as those outlined above (whether an annealing process or a high temperature hydrogen plasma process), a subsequent process may be used, such as an Ultra-High Vacuum (UHV) annealing process, in order to promote removal of carbon-hydrogen bonds in the graphene layers and encourage the promotion of carbon-carbon bonds between the graphene layers. This subsequent annealing can, for example, be performed at a lower pressure, such as a UHV pressure, for example about 10⁻⁸ Torr or less; and/or can be performed at a higher temperature than the hydrogenation process.

In accordance with an embodiment of the invention, two, three or more layers of graphene are formed together into a multiple layer graphene structure. The graphene can, in one embodiment, be epitaxial graphene, or, in another embodiment, it can be polycrystalline graphene. Polycrystalline graphene can be formed by a CVD (Chemical Vapor Deposition) process, which is low cost, and permits the graphene to be grown on copper, and a roll-to-roll process can be used in production. Epitaxial graphene is typically grown on a silicon wafer and is higher cost. Epitaxial may be preferable for some applications with which multiple layers of graphene can be used, for example in electronics and other applications. Polycrystalline graphene may be preferable where the lower cost is favorable, for example for use in creating high strength body armor using multiple layers of graphene. It will be appreciated that either epitaxial or polycrystalline graphene may be used. Where polycrystalline graphene is used, there is no need to control twist angles between layers of graphene, as may be done with epitaxial graphene. Where a roll-to-roll process is used to produce polycrystalline graphene, the graphene films may be produced using any known suitable roll-to-roll production technique for graphene films; for example, a technique may be used such as those taught in Bae, S., H. Kim, Y. Lee, X. Xu, J.-S. Park, Y. Zheng, J. Balakrishnan, T. Lei, H. Ri Kim, Y. I. Song, Y.-J. Kim, K. S. Kim, B. Ozyilmaz, J.-H. Ahn, B. H. Hong, S. Iijima, Roll-to-roll production of 30-inch graphene films for transparent electrodes. Nat Nano, 2010. 5(8): p. 574-578, the entire teachings of which are hereby incorporated herein by reference. After forming the films using a roll-to-roll process, the graphene films may then be stacked and covalent bonds formed between the graphene layers using any of the methods taught herein.

In some embodiments, epitaxial graphene can be used with controlled twist angles between layers of graphene, using techniques taught in U.S. Patent App. Pub. No. 2016/0207291, the entire teachings of which are hereby incorporated herein by reference. For example, in one embodiment, an article of manufacture includes a first graphene layer, a second graphene layer over the first graphene layer, the second graphene layer oriented at a first interlayer twist angle with respect to the first graphene layer and bonded by interlayer covalent bonds to the first graphene layer, and a third graphene layer over the second graphene layer, the third graphene layer oriented at a second interlayer twist angle with respect to the second graphene layer and bonded by interlayer covalent bonds to the second graphene layer. The first and second interlayer twist angles can each separately be in a range of between 0° and about 16°, or between about 44° and 60°, such that in some embodiments, the first and second interlayer twist angles can be equal, and in other embodiments, the first and second interlayer twist angles can be unequal to each other. In some embodiments, the first and second interlayer twist angles can be 0° or 60°, resulting in the formation of a two-dimensional (2D) diamond structure (nanodiamond). In certain embodiments, at least one of the first graphene layer, the second graphene layer, and the third graphene layer is a polycrystalline graphene layer.

In another embodiment, a method of making an article includes growing a first graphene layer on a silicon carbide wafer, exfoliating the first graphene layer onto a first transfer layer, disposing the first graphene layer and first transfer layer onto a host substrate, so that the first graphene layer is in contact with the host substrate surface, and removing the first transfer layer. The method then includes growing a second graphene layer on a silicon carbide wafer, exfoliating the second graphene layer onto a second transfer layer, disposing the second graphene layer and second transfer layer over the first graphene layer at a first interlayer twist angle with respect to the first graphene layer, so that the second graphene layer is in contact with the first graphene layer, and removing the second transfer layer. The method further includes covalently bonding the first and second graphene layers, the bonding involving a fraction of carbon atoms of each of the first and second graphene layers. Subsequent graphene layers can then be added by repeating the growing, exfoliating, disposing, removing, and bonding steps. The first graphene layer, the second graphene layer, and the third graphene layer, and the first and second interlayer twist angles are as described above. Interlayer covalent bonding is accomplished by any of the methods taught herein.

In yet another embodiment, a multi-layer graphene article includes at least three graphene layers, each graphene layer being oriented at an interlayer twist angle with respect to an adjacent graphene layer and bonded by interlayer covalent bonds to the adjacent graphene layer. The interlayer twist angle can be in a range of between 0° and about 16°, or between about 44° and 60°. Interlayer covalent bonding in the multi-layer graphene article is accomplished by any of the methods taught herein.

In one embodiment, the twist angle control is achieved by growing epitaxially single crystalline graphene monolayers on SiC wafers and subsequently transferring them one by one on top of each other onto a substrate of choice with a specific twist angle; the twist angle is accurately controlled by rotating the straight edge of one graphene layer with respect to its adjacent layer by a specific angle (the straight edge is caused by the SiC wafer flat).

In accordance with an embodiment of the invention, growth of 1-2 layer graphene on SiC can be achieved as follows. High-quality flat monolayer graphene can be grown epitaxially on the Si face of SiC (0001) wafers via a practically self-limiting decomposition of the SiC surface and sublimation of Si. (See Emtsev, K. V., Bostwick, A., Horn, K., Jobst, J., Kellogg, G. L., Ley, L., et al. (2009), “Towards wafer-size graphene layers by atmospheric pressure graphitization of silicon carbide,” Nature Materials, 8, 203-207; “Graphene: synthesis and applications” P. Avouris and C. Dimitrakopoulos, Mater. Today 15, 86-97 (2012)).

In another embodiment, a 4-inch epitaxial graphene sheet with a single orientation is grown on the Si-face (0001) of a 4H—SiC wafer with a miscut angle of 0.05° or lower. (See “Effect of SiC wafer miscut angle on the morphology and Hall mobility of epitaxially grown graphene” Dimitrakopoulos C., Grill A., McArdle T. J., Liu Z., Wisnieff R., Antoniadis D. A. Applied Physics Letters, 98, 222105 (2011)). The graphene formation is performed in a high-temperature chemical vapor deposition (CVD) reactor. The SiC substrate is annealed at a temperature in a range of between about 400° C. and about 1050° C., such as about 850° C., for a duration greater than about 1 minute, such as for 20 minutes, while evacuating the cell for surface cleaning in vacuum (i.e., at a pressure less than about 1×10³ mbar, such as about 1×10⁻⁶ mbar). The cell is then filled with H₂ up to a pressure in a range of between about 10 and about 1000 mbar, such as about 800 mbar, and the substrate temperature is raised to a temperature in a range of between about 1350° C. and about 2000° C., such as about 1545° C., for about 30 min, for H₂ to etch the top layers of SiC that might contain structural defects from the wafer fabrication and polishing process, oxidation or other non-volatile contaminants. The graphitization is performed at a pressure in a range of between about 1×10⁻³ mbar and about 1000 mbar, such as about 100 mbar, of Ar at a temperature in a range of between about 1450° C. and about 2000° C., such as about 1575° C., for a duration greater than about 1 minute, such as about 60 min.

In an embodiment, the graphene is completely exfoliated using a Ni adhesive-stressor layer and a thermally releasable tape handling layer. (See Dimitrakopoulos). This method of selective graphene exfoliation with single-layer precision is based on the binding energy differences between graphene and different metals. After the exfoliation of an epitaxial graphene layer from SiC using Ni as the first adhesive-strained layer (first exfoliation), the exposed additional graphene stripes are separated from the monolayer graphene sheet on Ni using a second adhesive strained layer (stripe exfoliation) followed by transfer onto another wafer. For the selective graphene stripe exfoliation, an Au layer is used as an adhesive-strained layer. (See Dimitrakopoulos).

In an embodiment, the same SiC wafer can be reused to generate many more similar graphene layers for the fabrication of the multi-layer twisted and covalently bonded graphene. In order to obtain comparable graphene quality from the second graphitization of the same SiC wafer after the transfer of the originally grown graphene, the surface of the wafer is thoroughly cleaned by dipping into FeCl₃ solution for complete removal of any Ni remnants and then using again the above described recipe. However, it is expected that the H₂ etching step duration could be reduced to 15 min or below, to minimize the use of SiC thickness consumed per graphene layer transferred.

In accordance with an embodiment of the invention, the twist angle control is achieved by growing epitaxially single crystalline graphene monolayers on SiC wafers and subsequently transferring them one by one on top of each other onto a substrate of choice with a specific twist angle. When two epitaxial graphene layers have been deposited one on top of the other with a specific twist angle, the bilayer is exposed to hydrogen or fluorine (or other reactive species that can form stable functionalized interlayer bonded structures), in order to break the pi structure of graphene locally and create interlayer bonding, accomplished by chemical functionalization, such as hydrogenation, fluorination, etc., which induces the formation of covalent sp³ C—C bonds between the previously sp²-bonded C atoms in the two adjacent graphene layers. (See A. R. Muniz and D. Maroudas, J. Appl. Phys. 111, 043513 (2012); A. R. Muniz and D. Maroudas, Phys. Rev. B. 86, 075404 (2012); A. R. Muniz and D. Maroudas, J. Phys. Chem. C 117, 7315 (2013)). A mild hydrogen or fluorine plasma can be used for this purpose. In addition, hydrogenation processes taught herein may be used, including Ar/hydrogen annealing and plasma processes. Atomic hydrogen is known to convert the conductive monolayer of graphene to insulating graphane. (See D. C. Elias, R. R. Nair, T. M. G. Mohiuddin, S. V. Morozov, P. Blake, M. P. Halsall, A. C. Ferrari, D. W. Boukhvalov, M. I. Katsnelson, A. K. Geim, K. S. Novoselov Science 323, 610 (2009)). While this reference describes complete conversion of the sp² monolayer of graphene to sp³ monolayer graphane, a lower concentration of atomic hydrogen in the flowing gas would ensure selective conversion of the theoretically predicted regions of twisted bilayer graphene to a bilayer connected covalently at the above-mentioned regions with covalent bonds. (See Machado, Appl. Phys. Lett. 103, 013113 (2013)). The dilution of reactive atomic hydrogen species can be achieved with controlling the flow of the carrier gas (either H₂ or an inert gas such as Argon). After the formation of the first bilayer with localized covalent bond arrangements, as predicted by Machado, a third graphene layer can be transferred and placed on top of the bilayer at a specific angle, using the transfer method described above and another round of hydrogenation, fluorination or other functionalization can follow to induce covalent bonding between the top two layers (layer 2 and 3), including any of the hydrogenation techniques taught herein. These process steps can be repeated many times until the desired covalently bonded graphene multi-layer thickness is reached.

In accordance with an embodiment of the invention, bilayer, trilayer or multiple layers of graphene may be used to form a wide variety of different possible materials for use in a wide variety of different possible applications, including without limitation to create high strength barriers and structural materials, nano-electromechanical systems, in electronics, and to create body armor. In one embodiment, bilayer, trilayer or more than three layers of graphene are bonded together using methods in accordance with an embodiment of the invention to create a body armor material.

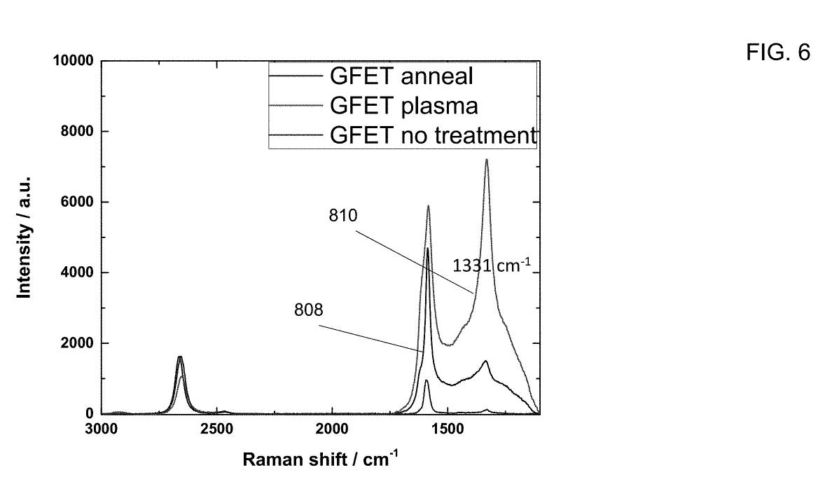

FIG. 6 is a diagram of the results of Raman spectroscopy before and after each of an annealing process 808 and a plasma treatment 810 for hydrogenation of graphene layers, in accordance with an embodiment of the invention. A Raman spectrum of three-layer graphene before and after 400° C. annealing and 400° C. plasma treatment is shown. It can be seen that the plasma treatment 810 appears to create higher peaks at both the 1590 cm⁻¹ peak, which is for C—C bonds, and the 1331 cm⁻¹ peak, which is for sp³ configuration bonds.

For a plasma hydrogenation treatment, in accordance with an embodiment of the invention, it is believed that a temperature between about 25° C. and 600° C. can be used, for example. Higher temperatures up to about 1000° C. can also be used, but it is possible that etching can occur at higher temperatures. A time of between about 30 seconds and about 10 minutes can be used.

For an annealing hydrogenation treatment in accordance with an embodiment of the invention, a temperature of between about 400° C. and about 1000° C. can be used, for a time of up to an hour, for example, or between about 10 minutes and about 6 hours. Such an annealing process can, for example, be performed with a hydrogen-containing gas, such as an Argon carrier gas with a hydrogen gas.

Subsequently, after a hydrogenation treatment, a hydrogen removal treatment may be applied. For example, an Ultra-High Vacuum (UHV) treatment may be applied, for example at a pressure less than about 10⁻⁸ Torr, or, for example, a removal treatment may be performed in an inert environment, such as by passing a stream of an inert gas such as Helium or Argon over the graphene layers while performing an annealing treatment to remove hydrogen. The goal in this step can be to remove hydrogen produced as result of breaking a carbon-hydrogen bond, and therefore the UHV or inert environment can assist with removing the hydrogen produced.

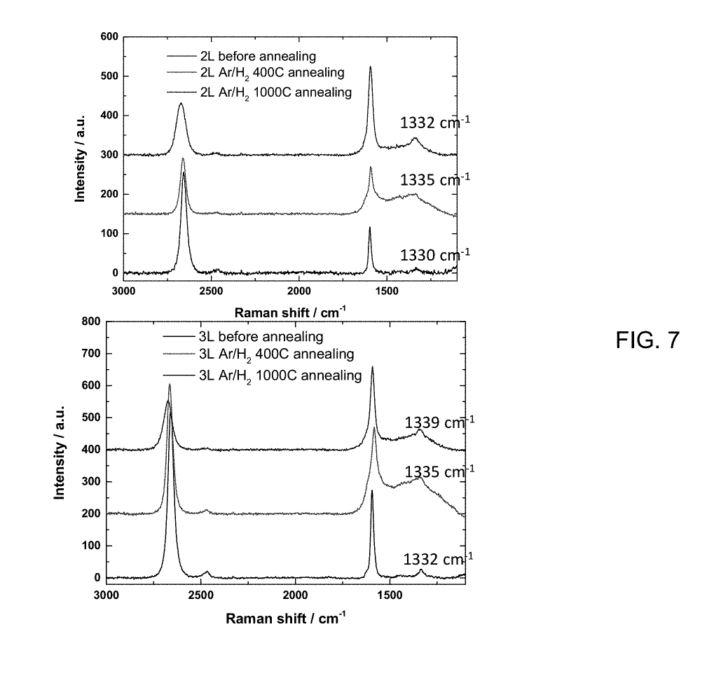

FIG. 7 is a diagram of the results of Raman spectroscopy before and after an annealing process at 400° C. and 1000° C. for hydrogenation in both two-layer and three-layer graphene, in accordance with an embodiment of the invention. In each graph, the top trace is 1000° C. annealing, the middle trace is 400° C. annealing and the bottom trace is before annealing.

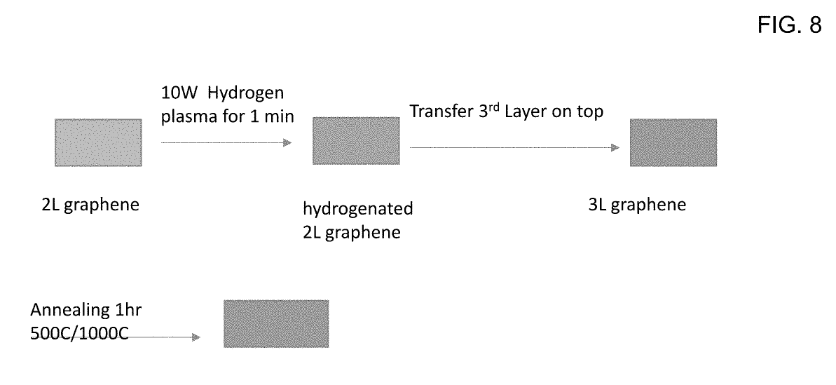

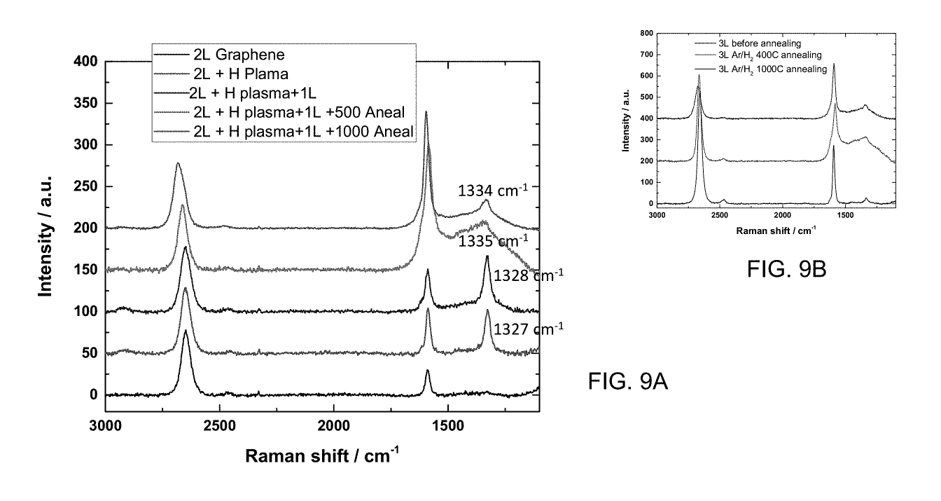

FIG. 8 is a schematic block diagram of a method in accordance with an embodiment of the invention. Here hydrogenation is performed, using plasma, on a second layer of graphene, the third layer is transferred, and then an annealing process is performed. On the two-layer graphene, a 10 W hydrogen plasma process is performed for 1 minute, to produce hydrogenated two-layer graphene; then a third layer of graphene is transferred on top; and then a one hour 500° C./100° C. annealing is performed. FIG. 9A is a diagram of the results of Raman spectroscopy after the process of the embodiment of FIG. 8. In FIG. 9A, the key from top to bottom corresponds to the traces from bottom to top. It can be seen that a 500° C. Anneal, performed after the plasma hydrogenation, produces a high peak at about 1590 cm⁻¹. The results are similar to a technique using a three-layer transfer all together followed by treatment, shown in FIG. 9B, in which the key from top to bottom corresponds to the traces from bottom to top. A temperature between about 400 and about 600° C. can, for example, be used for a subsequent annealing step.

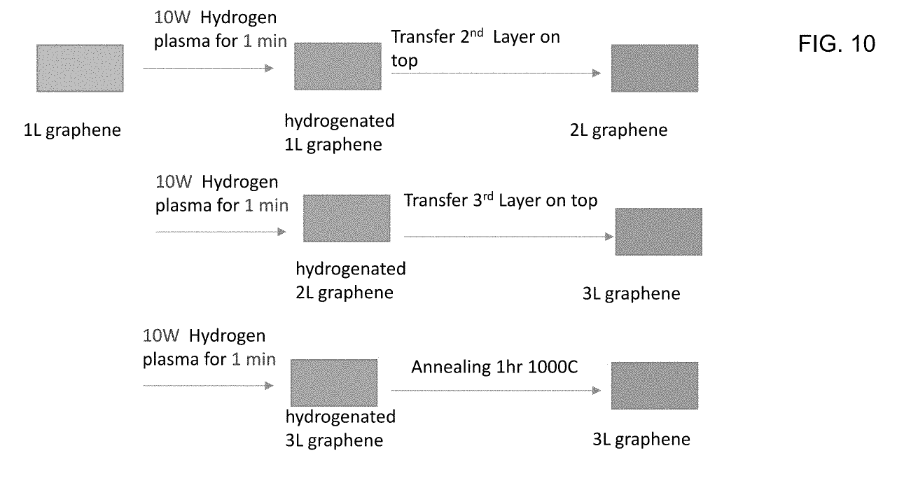

FIG. 10 is a schematic block diagram of another method in accordance with an embodiment of the invention. In this embodiment, all three layers are hydrogenated, and then annealing is performed at the end. It will be appreciated that the power and time can be changed. In this example, on one layer of graphene, a 10 W hydrogen plasma is applied for 1 minute, to produce hydrogenated one layer graphene; then a second layer is transferred on top, to produce two layer graphene; then a 10 W hydrogen plasma is applied for one minute to produce hydrogenated two layer graphene; then a third layer is transferred on top to produce three layer graphene; then a 10 W hydrogen plasma is applied for one minute to produce hydrogenated three layer graphene; then a one hour 1000° C. annealing is performed to produce three layer graphene.

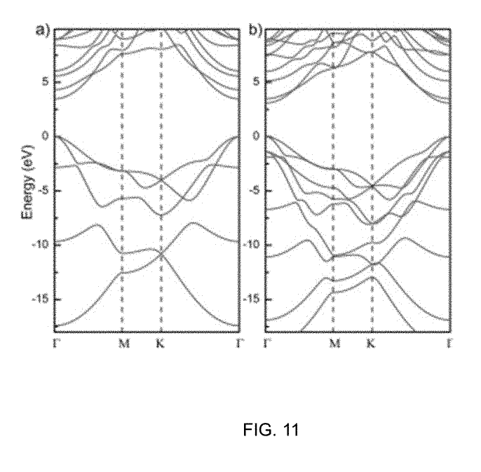

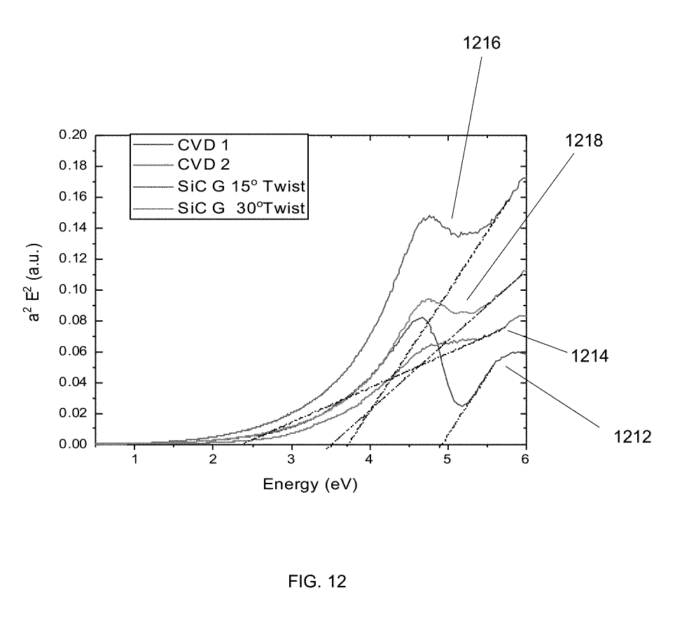

In accordance with an embodiment of the invention, experiments were performed, which provide supporting evidence for the existence of a bandgap in treated graphene bilayers and multilayers as taught herein. In the experiments, the optical transmission and absorption coefficient of graphene and hydrogenated graphene (H-Gr) were measured at room temperature via visible-ultraviolet spectrometry (LAMBDA 950 UV/Vis Spectrophotometer) over the wavelength range of 175-3300 nm at normal incidence. The optical bandgap of several samples that had undergone different processing were examined. These optical absorption experiments support the formation and tunability of a band gap in graphene structures (bilayers and multilayers) induced by plasma and heat treatment processes taught herein. In literature, the optical bandgap of H-Gr monolayers (as estimated from the higher-lying absorption background) ranged from 1.4 to 4.6 eV, depending on the hydrogen coverage, which is mainly due to direct (vertical) band-to-band excitation. See Son, J., et al., Hydrogenated monolayer graphene with reversible and tunable wide band gap and its field-effect transistor. Nature Communications, 2016. 7 (here, “Son J. et al.”). Graphane is the completely hydrogenated graphene structure. The graphane band structure is shown in FIG. 11, in accordance with the prior art. The left panel, panel (a), of FIG. 11 shows the electronic band structure of monolayer graphane, and the right panel, panel (b), shows the electronic band structure of bilayer graphane. The energies are relative to the Fermi level E_{F}=0. After an annealing treatment in inert atmosphere (e.g. Argon), graphane converts completely to graphene, and thus the band gap disappears. However, in the case of the samples in the experiment, after a similar annealing treatment in inert atmosphere (e.g. Argon), such bandgap still remains, and the optical bandgap of the hydrogenated sample after such anneal in inert atmosphere ranged from 2.5 eV to 4.75 eV, (shown in FIG. 12) noting the nonreversible bandgap of H-Graphene bilayers and multilayers after anneal in inert atmosphere and the probable interlayer bond formation. In FIG. 12 the methodology of Son J. et al. was used to calculate the optical bandgap. FIG. 12 shows the evolution of optical (near infrared, visible and ultraviolet) absorption spectra of interlayer bonded bilayers and their estimated bandgaps. In the figure, α is the optical absorption coefficient and E is the incident photon energy. Traces for CVD graphene (two traces, 1212 and 1214) and SiC graphene with a 15 degree twist angle 1216 and 30 degree twist angle 1218 are shown.

As used herein, the terms “carbon-carbon” bond and “C—C” bond are used interchangeably to refer to a covalent bond between two carbon atoms.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A method of forming an interlayer bond between two or more layers of graphene, the method comprising:
positioning at least two layers of graphene in a stacked arrangement; and
performing a hydrogenation treatment on the at least two layers of graphene to induce formation of carbon-carbon covalent bonds between carbon atoms on different neighboring layers of the at least two layers of graphene for at least a portion of the carbon atoms on at least a portion of the area of the at least two layers of graphene.

2. The method of claim 1, wherein the performing the hydrogenation treatment comprises performing an annealing process on the at least two layers of graphene in the stacked arrangement.

3. The method of claim 2, wherein the performing the annealing process comprises performing an annealing process in the presence of at least hydrogen gas at a temperature between about 400° C. and about 1000° C.

4. The method of claim 2, wherein the annealing process is performed in the presence of hydrogen gas and a carrier gas.

5. The method of claim 4, wherein the carrier gas comprises argon.

6. The method of claim 1, wherein the performing the hydrogenation treatment comprises performing a plasma process on the at least two layers of graphene in the stacked arrangement.

7. The method of claim 6, wherein the plasma process comprises a hydrogen plasma process.

8. The method of claim 6, wherein the plasma process is performed at a temperature between about 25° C. and 600° C.

9. The method of claim 1, further comprising performing a subsequent hydrogen removal treatment on the at least two layers of graphene.

10. The method of claim 9, wherein the subsequent hydrogen removal treatment comprises annealing under Ultra-High Vacuum (UHV) conditions.

11. The method of claim 10, wherein the UHV conditions comprise a pressure of less than about 10⁻⁸ Torr.

12. The method of claim 9, wherein the subsequent hydrogen removal treatment is performed during production of more than three layers of graphene and after more than two layers of graphene have been treated according to the method of claim 1.

13. The method of claim 9, wherein the subsequent hydrogen removal treatment is performed at a temperature between about 400° C. and about 600° C.

14. The method of claim 1, wherein the at least two layers of graphene comprise epitaxial graphene.

15. The method of claim 1, wherein the at least two layers of graphene comprise polycrystalline graphene.

16. A method of breaking the planar configuration of graphene in at least a portion of the area of at least two different neighboring layers of graphene to create sp³ configuration bonds and thereby to create a tetrahedral geometry in at least portion of the carbon atoms of each of the neighboring layers of graphene, the method comprising:
positioning at least two layers of graphene in a stacked arrangement; and
performing a hydrogenation treatment on the at least two layers of graphene to induce formation of carbon-carbon covalent bonds between carbon atoms on different neighboring layers of the at least two layers of graphene for at least a portion of the carbon atoms on at least a portion of the area of the at least two layers of graphene.

17. The method of claim 16, wherein the performing the hydrogenation treatment comprises performing an annealing process on the at least two layers of graphene in the stacked arrangement.

18. The method of claim 16, wherein the performing the hydrogenation treatment comprises performing a plasma process on the at least two layers of graphene in the stacked arrangement.

19. The method of claim 16, further comprising performing a subsequent hydrogen removal treatment on the at least two layers of graphene.
